(19) United States
(12) Patent Application Publication
(10) Pub. No.: US 2009/0323477 A1
(43) Pub. Date: Dec. 31, 2009

(54) UNIVERSAL WRISTWATCH AND RELEVANT TIME SETTING SYSTEM IN TWELFTHS AND TWENTY-FOURTHS ACCORDING TO THE DIFFERENT TIME ZONE

(75) Inventor: Ruggero Ferrari, Parma (IT)

Correspondence Address: YOUNG & THOMPSON, 209 Madison Street, Suite 500, Alexandria, VA, 22314, US

(73) Assignee: Marisa MARCHIGNOLI, Parma (IT)

(21) Appl. No.: 12/527,599

(22) PCT Filed: Feb. 20, 2007
(86) PCT No.: PCT/IT07/00116

§ 371 Date: Aug. 18, 2009

(51) Int. Cl. G04B 19/22

(52) U.S. Cl. 368/27

(57) ABSTRACT

Universal wristwatch and the relevant system for setting the time according to the time zone. The wristwatch (1) comprises concentric dials (A5 B5-C) showing the 24 hours (dial B) 5 the 24 time zones (dial C) and the minutes (winder A) and comprises also selecting devices (11) suitable to implement a temporary-connection between the rotation of the time zone dial (C) and. the 24-hour dial (B) in order to realise an identical synchronous rotation further to which it will be possible to set the hour hand (O) on the new place thus obtaining independently and at the same time the collimation with the joint unit of dials (B) and (C). Once the aforesaid collimation is completed, the previous different rotation of dials (B) and (C) is restored. The result is to have the wristwatch (1) showing the time of the current time zone in twelfths and twenty-fourths, universal wristwatch, in addition to the other 23 places.

The present invention deals with a universal wristwatch and the relevant time setting system in twelfths and twenty-fourths according to the new time zone.

A prior art example is described in the Swiss patent N. CH260633, one of the foremost patent that has realised fundamental innovations in the field of universal wristwatches, such as:
time graduation 1-24 h with clockwise numbering and rotation,
double planisphere rotation with all the 24 time zones, still with clockwise rotation,
setting at the centre of the clock (for the 24 time zones) the South Pole instead of the North Pole, as unsuitably proposed by some clock makers.

The solution proposed was yet at that time revolutionary and it has been implemented in the course of the years.

The solution proposed at that time and all the solutions implemented at present, however, have not evolved since they are still stopped at incomplete solutions and not adequate to have a satisfactory time overview.

More particularly the solutions adopted up to now do not meet the requirements of the modern traveller which, due to present-day globalisation and speediness of the means of transport and communication, needs to know exactly the time in other parts of the globe and to set properly his/her wristwatch each time the time zone changes in order to be synchronised with local clocks.

A universal wristwatch like those implemented up to now shows the inconvenience to be steadily conditioned by the time zone where it is lying: for all the other time zones there will be, as usual, two separate and independent clocks.

Object of the present invention is removing the above mentioned inconveniences by means of devices suitable to promptly enable the normal 1-12 wristwatch to show, wherever it may be on earth, the time both in twelfths and in twenty-fourths, at the same time and together with the time of the other 23 time zones.

In this way the wristwatch is always both normal and universal, wherever it may be.

It makes no matter either the time zone where you are or the time zone where you have to go: with the system object of the present invention it will be possible to intervene immediately on the hour hand winder.

These objects and advantages are all obtained by the universal wristwatch subject of the present invention, which is characterised by what is provided in the below listed claims.

This and other characteristics will be better pointed out by the following description of some embodiments shown, merely as a non-limiting example, in the enclosed tables of drawing in which:

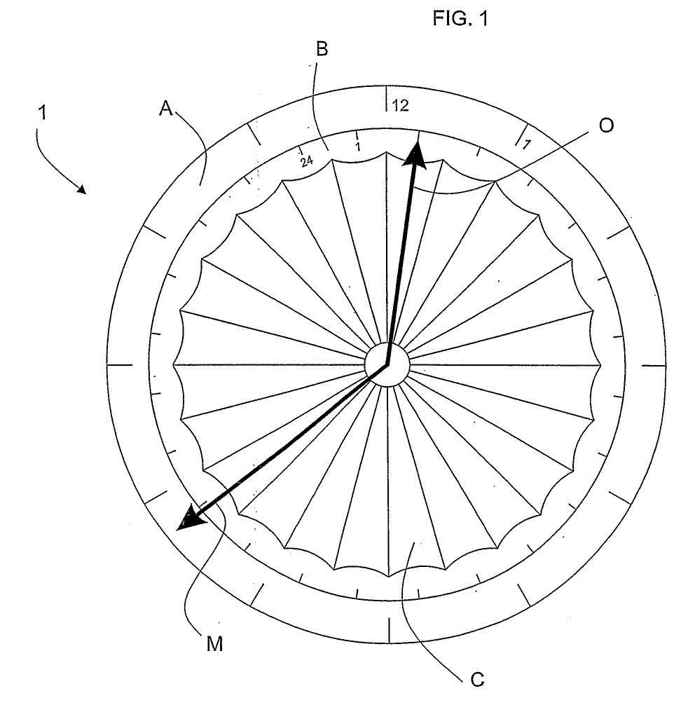

FIG. 1 shows a front view of a universal wristwatch subject of the present invention.

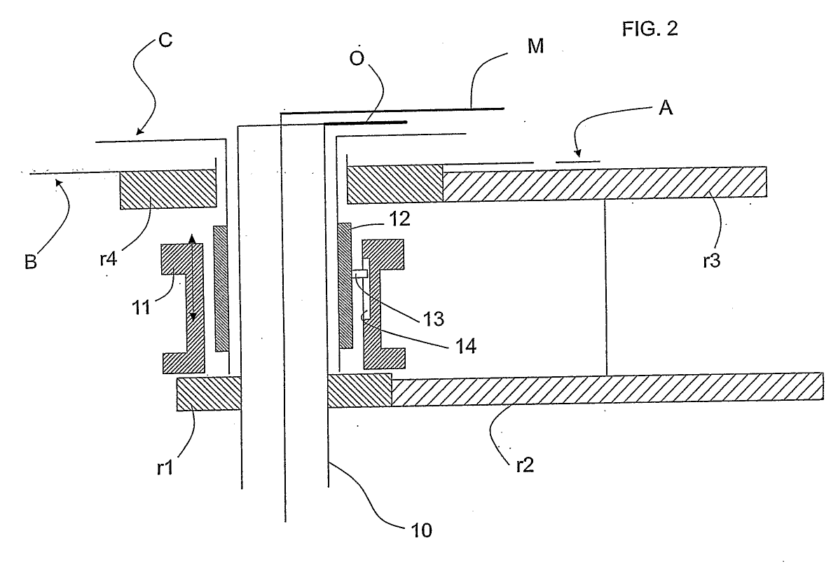

FIG. 2 shows a conventional representation of the system for setting the rotation of the dials of the universal wristwatch subject of the present invention.

With reference to FIG. 1, 1 designates a universal wristwatch in its whole, which in addition to time (1 to 12 h), like common wristwatches, shows also the time of every time zone as well as the day of every time zone with respect to the day of the local time zone.

The universal wristwatch 1 consists of:
1. an outer fixed winder A graduated in 12 hours and 60 minutes like in common wristwatches, that shows hours and minutes,
2. a smaller 24-hour graduated dial B with internal and concentric numbering increasing clockwise and making one complete turn clockwise in 24 hours;
3. a dial C completing clockwise two turns a day, concentric and internal to the above two graduations A and B; on the surface of this dial C being represented a planisphere with the South Pole in the middle, or as an alternative only twenty-four or forty-eight places, provided with 24 equidistant peripheral hands showing the time of the 24 time zones in which the planisphere is subdivided.
4. an hour hand O, completing two turns clockwise in 24 hours,
5. an hand M, completing one turn clockwise in 1 hour, shows the minutes, identical for all time zones.

The above mentioned dials A, B, C are concentric: as stated the first dial is fixed whereas the other two dials rotate around shaft D of minutes M clockwise: dial B makes one complete turn in 24 hours and dial C makes two turns in the 24 hours like the common hour hand O.

In this way the planisphere makes two complete turns with respect to the fixed graduation (designated with A) and just one turn with respect to dial B; this enables to obtain for the time zone of interest the time indication in twelfths and twenty-fourths like in common watches and also to make use of the wristwatch like a universal watch.

With the present invention, when changing time zone it is possible to intervene by setting the hour hand O for the new time zone in order to be always informed about local time and to have automatically, independently and at the same time the universal indication of the other time zones by means of the time zone dial, i.e.: dial C.

In fact, the wristwatch 1 subject of the present invention comprises suitable devices for connecting temporarily the rotation of the time zone dial C with the hour dial B, dial (1-24), in order to realise an identical synchronous rotation.

Then, setting the hour hand to the new required place will obtain, at the same time and independently, the collimation of the single unit “dial 1-24+time zone dial” on the aforesaid new place.

Once the above mentioned collimation is completed, repositioning the aforesaid devices to the original configuration will restore the previous different rotation of dials B and C.

With reference to FIG. 2 a preferred system representation is shown, with the devices suitable to connect temporarily the dials B and C.

More particularly the hour shaft 10 is shown, which transmits by gear kinematic chain r1, r2, r3, r4 motion to dial B, being the gear r4 integral with it; gear ratio is 2:1, i.e.: to each turn of the shaft 10 corresponds a half turn of the dial B (the 1-24 hour dial).

The time zone dial C is coupled to the shaft by means of the coupling 12 which is turned by the coaxial and external selector 11 through the sliding pin 13 and engaged in the groove 14.

In a typical operation configuration the selector 11 is connected to gear r1, thereby to each turn of the shaft 10 (therefore of the hours O and minutes M) corresponds a turn of the time zone dial C, thus confirming the ratio 2:1 between dials B and C.

When changing time zone, using the proper button or mechanism it will be possible to intervene on the selector 11 by disconnecting it from the coupling with r1 and setting it close to r4 in order to implement a temporary connection between the rotation of the time zone dial C and the 1-24 hour dial B. It will then be possible by clockwise or counter-clockwise rotation according to the new time zone, to set the hour hand O on the new place thus obtaining independently and at the same time the collimation with the joint unit of dials B and C.

Operating again the selector 11 and restoring the coupling with r1 will restore the original operating situation with the aforesaid ratios.

Since the minute hand M makes one complete turn in 60 minutes whereas the hour hand O, and therefore the shaft 10, make a feed of 15° (360/24) at every complete turn of the minute hand M, a suitable kinematic chain will be implemented to obtain said ratio between the components—embodiment not shown since self-evident.

The example refers to a mechanical combination suitable to realise the time setting system as described in the claims which follow, all equivalent implementations are nevertheless subject to the scope of the invention.

1. Universal wristwatch (1), of the type comprising dials, or graduations, (A, B, C) concentric, consisting of
a. an outer fixed winder (A) graduated in 12 hours and 60 minutes like in common wristwatches, that shows hours and minutes,
b. a smaller 24-hour graduated dial (B) with internal and concentric numbering increasing clockwise and making one complete turn clockwise in 24 hours;
c. a dial (C) completing clockwise two turns a day, concentric and internal to the two aforesaid graduations (A) and (B); on the surface of this dial (C) being represented a planisphere with the South Pole in the middle, provided with 24 equidistant peripheral hands showing the time of the 24 time zones in which the planisphere is subdivided, with the indication of at least 24 toponyms.
d. an hour hand (O), completing two turns clockwise in 24 hours,
e. an hand (M), completing one turn clockwise in 1 hour, showing the minutes, identical for all time zones.
characterised in that it comprises selecting devices (11) suitable to implement a temporary connection between the rotation of the time zone dial (C) and the 1-24 hour dial (B), in order to realise an identical synchronous rotation further to which it will be possible to set the hour hand (O) on the new place thus obtaining independently and at the same time the collimation with the joint unit of dials (B) and (C); the aforesaid selecting devices (11) being repositioned to the original configuration after completing the above mentioned collimation, thus restoring the previous ratio between dials (B) and (C) as a consequence.

2. Setting system for a universal wristwatch (1) of the type comprising dials or graduations (A, B, C) concentric, i.e.:
a. an outer fixed winder (A) graduated in 12 hours and 60 minutes like in common wristwatches, that shows hours and minutes,
b. a smaller 24-hour graduated dial (B) with internal and concentric numbering increasing clockwise and making one complete turn clockwise in 24 hours;
c. a dial (C) completing clockwise two turns a day, concentric and internal to the two aforesaid graduations (A) and (B); on the surface of this dial (C) being represented a planisphere with the South Pole in the middle, provided with 24 equidistant peripheral hands showing the time of the 24 time zones in which the planisphere is subdivided.
d. an hour hand (O), completing two turns clockwise in 24 hours,
e. an hand (M), completing one turn clockwise in 1 hour, showing the minutes, identical for all time zones.
characterised in that it provides the temporary connection between the time zone dial (C) and the hour dial (B) in order to realise an identical synchronous rotation.

3. Setting system according to claim 2, characterised in that the aforesaid connection enables to set the hour hand (O) on the new place and to obtain at the same time and independently the collimation with the joint unit of dials (B) and (C), thus showing the local time in twelfths and twenty-fourths.

4. Setting system according to claim 2, characterised in that it provides to restore the different rotation of dials (B) and (C) after completing the collimation and setting the time zone.

5. Setting system according to claim 2, characterised in that it provides as an alternative to or in combination with the planisphere representation on dial (C) the indication of 24 or 48 toponyms.

6. Setting system according to claim 3, characterised in that it provides as an alternative to or in combination with the planisphere representation on dial (C) the indication of 24 or 48 toponyms.

7. Setting system according to claim 4, characterised in that it provides as an alternative to or in combination with the planisphere representation on dial (C) the indication of 24 or 48 toponyms.

8. Setting system according to claim 1, characterised in that it provides to restore the different rotation of dials (B) and (C) after completing the collimation and setting the time zone.

9. Setting system according to claim 8, characterised in that it provides as an alternative to or in combination with the planisphere representation on dial (C) the indication of 24 or 48 toponyms.
